(19) United States
(12) Patent Application Publication
(10) Pub. No.: US 2013/0100061 A1
(43) Pub. Date: Apr. 25, 2013

(54) MOBILE TERMINAL AND CONTROLLING METHOD THEREOF

(71) Applicant: KYOCERA Corporation, Kyoto-shi (JP)

(72) Inventor: Toshikazu KAWAUCHI, Nishinomiya-shi (JP)

(73) Assignee: KYOCERA CORPORATION, Kyoto-shi (JP)

(21) Appl. No.: 13/658,083

(22) Filed: Oct. 23, 2012

(30) Foreign Application Priority Data
Oct. 24, 2011 (JP) 2011-232487

(51) Int. Cl. G06F 3/041

(52) U.S. Cl. 345/173

(57) ABSTRACT

A mobile terminal is a smartphone as one example, and provided with a touch panel and a setting key. A processor of the mobile terminal sets, based on an operation of the setting key by a user, a low sensitivity region that is lowered sensitivity than a central portion in a peripheral edge portion of the touch panel.

### CROSS REFERENCE OF RELATED APPLICATION

The disclosure of Japanese Patent Application No. 2011-232487 is incorporated herein by reference.

### BACKGROUND OF THE INVENTION

1. Field of the Invention

The present invention relates to a mobile terminal and a controlling method thereof, specifically a mobile terminal which is provided with a touch panel on a display thereof and a controlling method of such a mobile terminal.

2. Description of the Related Art

Such a kind of mobile terminal is disclosed in a related art described below. In a mobile phone in this related art, in performing an input operation with using a touch panel provided on a display, a plurality of icons are displayed on an operating surface, and an erroneous operation of a touch panel input is reduced by displaying the icon the longer distance from a base point in the vicinity of a peripheral edge portion of the display, the bigger size.

For example, in a case that an input operation is to be performed with using a touch panel provided on a mobile terminal, a user holds the mobile terminal by one hand, and in such a state, moves a thumb as a fulcrum at a root of the thumb of the hand to perform a touch operation. However, at a timing of such an input operation, a portion of the root of the thumb is easy to come in contact with the touch panel, and therefore, there is an occasion that malfunction that an operating key or icon that the user does not intend to operate reacts, that a displayed image is unintentionally scrolled, or the like occurs. Furthermore, if and when the user wishes to show another person an image being displayed on a display, the user may face the display to the person or the user may hand the mobile terminal itself to the person, and in such a case, a fingertip of the user or the like is unintentionally brought into contact with the touch panel and thus similar malfunction occurs.

The occurrence of the malfunction due to the unintentional contact with the touch panel appears remarkably especially in a mobile terminal such as a smartphone or the like in which a display is made a big screen and thus a frame width is made small while an input-effective area of the touch panel is formed in an approximately entire range of a displaying area of the display.

### SUMMARY OF THE INVENTION

Therefore, it is a primary object of the present invention to provide a novel mobile terminal and controlling method thereof.

Another object of the present invention is to provide a mobile terminal and controlling method thereof capable of reducing occurrence of an erroneous operation due to an unintentional contact with a touch panel.

The present invention employs following features in order to solve the above-described problems. It should be noted that reference numerals and the supplements inside the parentheses show one example of a corresponding relationship with the embodiments described later for easy understanding of the present invention, and do not limit the present invention.

A first aspect according to the present invention is a mobile terminal provided with a touch panel, comprising: a setting inputting portion; and a setting portion which sets, based on an operation by a user to the setting inputting portion, a low sensitivity region that is lowered sensitivity than a central portion in a peripheral edge portion of the touch panel.

A second aspect according to the present invention is a mobile terminal provided with a touch panel, comprising: a setting portion which sets a low sensitivity region that is lowered sensitivity than a central portion in a peripheral edge portion of the touch panel.

A third aspect according to the present invention is a controlling method of a mobile terminal which includes a setting inputting portion and a touch panel provided on a display, comprising step of: setting, based on an operation to the setting inputting portion by a user, a low sensitivity region that is lowered sensitivity than a central portion in a peripheral edge portion of the touch panel.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is appearance views showing a mobile terminal of one embodiment according to the present invention, and FIG. 1(A) is a perspective view from a front surface side and FIG. 1(B) is a perspective view from a rear surface side.

FIG. 2 is an illustrative view showing electric structure of the mobile terminal shown in FIG. 1.

FIG. 3 is an illustrative view showing a manner that a user operates a touch panel of the mobile terminal.

FIG. 4 is an illustrative view showing a manner that a user holds the mobile terminal.

FIG. 5 is illustrative views showing a manner of a low sensitivity region set on the touch panel, and FIG. 5(A) shows a state of a normal sensitivity mode that no low sensitivity region is set, and FIG. 5(B) shows a state of a low sensitivity mode that a low sensitivity region is set.

FIG. 6 is an illustrative view showing an example of a memory map of a RAM shown in FIG. 2.

FIG. 7 is a flowchart showing an example of an operation of low sensitivity region setting process by a processor shown in FIG. 2.

FIG. 8 is an illustrative view showing a further example of a manner of a low sensitivity region set on the touch panel.

FIG. 9 is an illustrative view showing a still further example of a manner of a low sensitivity region set on the touch panel.

FIG. 10 is an illustrative view showing the other example of a manner of a low sensitivity region set on the touch panel.

### DETAILED DESCRIPTION OF THE PREFERRED EMBODIMENTS

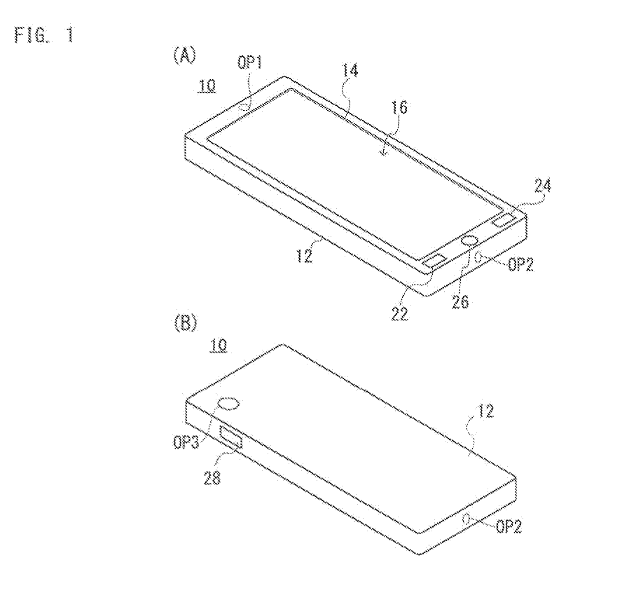

With referring to FIG. 1, a mobile terminal 10 of one embodiment according to the present invention is a smartphone as one example, and includes a longitudinal flat rectangular housing 12. However, it is pointed in advance that a word “mobile terminal” is used in a concept including a terminal or an electronic device used portably such as a conventional feature phone, a tablet terminal, a PDA, a digital camera, etc., and the present invention can be applied to an arbitrary mobile terminal.

A display 14 such as a liquid crystal, organic EL or the like is provided on a main surface (front surface) of the housing 12. A touch panel 16 is provided on the display 14. An input-effective area of the touch panel 16 is formed in approximately entire range of a displaying area of the display 14. In the embodiment, the touch panel 16 is of an electrostatic capacitance system that detects a change of an electrostatic capacitance between electrodes, which occurs when an object such as a finger is in close to a surface of the touch panel 16, and it is detected that one or more fingers is brought into contact with the touch panel 16, for example. In addition, the touch panel 16 is a pointing device which is provided on the display 14 and designates an arbitrary position within a screen of the display 14. That is, the user can input an operating position, an operating direction and so on to the mobile phone 10 by performing a touch operation such as pushing, stroking, or touching the surface of the touch panel 16.

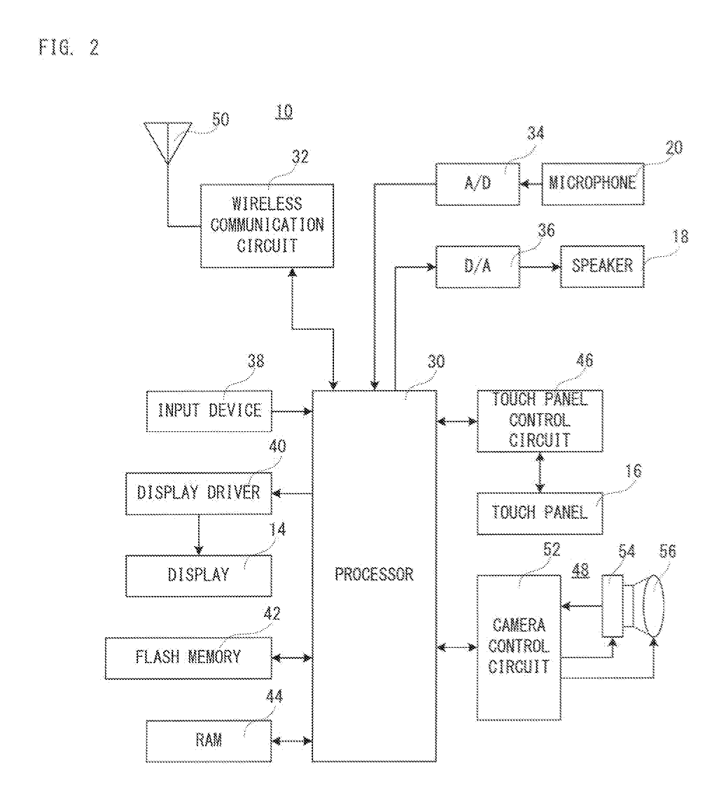

A speaker 18 (see FIG. 2) is housed in the housing 12 at a side of the front surface at one end of a longitudinal direction, and an opening OP1 communicated with the speaker 18 is formed on a surface of the housing 12. Furthermore, a microphone 20 (see FIG. 2) is housed at the other end in the longitudinal direction of the housing 12, and an opening OP2 communicated with the microphone 20 is formed an end surface of the housing 12.

As a hard key constituting an inputting portion together with the touch panel 16, in this embodiment, a call key 22, an end key 24 and a menu key 26 are provided on the front surface of the housing 12 at a side of the other end.

For example, the user can input a telephone number by making a touch operation on the touch panel 16 with respect to a dial key (not shown) displayed on the display 14, and start a telephone conversation by operating the call key 22. If and when the end key 24 is operated, the telephone conversation can be ended. In addition, by long-depressing the end key 24, it is possible to turn-on/-off a power of the mobile terminal 10.

If the menu key 26 is operated, a menu screen is displayed on the display 14, and in such a state, by making a touch operation on the touch panel 16 against a soft key, a menu icon or the like (not shown)being displayed on the display 14, it is possible to select a menu and to decide such a selection. In addition, the above-described menu key 26 functions as a shutter key or imaging key in a case that the mobile terminal 10 is set to a camera mode.

A camera opening OP3 for a camera module 48 (see FIG. 2) described later is formed on the other surface (rear surface) of the housing 12. Therefore, the camera module 48 images or takes an image through the opening OP3. That is, if it is intended to take a picture by the camera module 48 in the mobile terminal 10 of this embodiment, the camera opening OP3 is oriented to an object, and then, the menu key 26 functioning as the imaging key is operated.

Furthermore, in this embodiment shown, a setting key 28 is provided on a side surface of the housing 12. As described later in detail, the setting key 28 is a hard key which functions as a setting inputting portion for setting, in a peripheral edge portion of the touch panel 16, a low sensitivity region 60 (see FIG. 5) where sensitivity of the touch panel 16 is lowered than sensitivity in a central portion of the touch panel 16. A user can select, by changing turn-on/turn-off of the setting key 28, either a low sensitivity mode that the low sensitivity region 60 is set in a peripheral edge portion of the input-effective area of the touch panel 16 or a normal sensitivity mode that the same sensitivity is set in an entire input-effective area of the touch panel 16. That is, by utilizing the setting key 28, the user can easily set the low sensitivity region 60.

FIG. 2 is a block diagram showing electrical structure of the mobile terminal 10. With referring to FIG. 2, the mobile terminal 10 includes a processor 30 called as a computer or a CPU. The processor 30 is connected with a wireless communication circuit 32, an A/D converter 34, a D/A converter 36, an input device 38, a display driver 40, a flash memory 42, a RAM 44, a touch panel control circuit 46, a camera module 48, etc.

The processor 30 is in charge of a whole control of the mobile terminal 10. All or a part of a program set in advance on the flash memory 42 is, in use, developed into the RAM 44, and the processor 30 operates in accordance with the program in the RAM 44. In addition, the RAM 44 is further used as a working area or buffer area for the processor 30.

The input device 38 includes the touch panel 16 and the hard keys 22, 24, 26 and 28 shown in FIG. 1 and constitutes an operating portion or inputting portion. Information (key data) of the hard key operated by the user is input to the processor 30.

The wireless communication circuit 32 is a circuit for transmitting and receiving a radio wave for a telephone conversation and a mail via an antenna 50. In this embodiment, the wireless communication circuit 32 is a circuit for performing a wireless communication in a CDMA system. For example, if the user designates a telephone dispatch (telephone call) using the input device 38, the wireless communication circuit 32 performs a telephone call processing under instructions from the processor 30 and outputs a telephone call signal via the antenna 50. The telephone call signal is transmitted to a telephone at the other end of the line through a base station and a communication network (not shown). Then, an income processing is performed in the telephone at the other end of the line, a communication-capable state is established and the processor 30 performs the telephone conversation processing.

The microphone 20 is connected to the A/D converter 34, a sound signal from the microphone 20 is input to the processor 30 as digital sound data through the A/D converter 34. The speaker 18 is connected to the D/A converter 36. The D/A converter 36 converts digital sound data into an analog sound signal so as to apply to the speaker 18 via an amplifier (not shown). Therefore, a sound or voice of the sound data is output from the speaker 18.

In addition, the processor 30 adjusts, in response to an operation of a volume (not shown) by the user, a sound volume of the sound output from the speaker 18 by controlling an amplification factor of the amplifier connected to the D/A converter 36.

The display driver 40 is connected with the display 14 shown in FIG. 1, and therefore, the display 14 displays an image or video in accordance with image or video data output from the processor 30. That is, the display driver 40 controls the displaying by the display 14 connected to the same under instructions by the processor 30. In addition, the display driver 40 includes a video memory (not shown) which temporarily stores the image or video data to be displayed. The display 14 is provided with a backlight which includes a light source of an LED or the like, for example, and the display driver 40 controls, according to the instructions of the processor 30, brightness, light-on/off of the backlight.

The touch panel 16 shown in FIG. 1 is connected to the touch panel control circuit 46. The touch panel control circuit 46 applies a necessary voltage, etc. to the touch panel 16, and functions as a touch detecting portion, and detects a touch operation within the input-effective area of the touch panel 16 so as to output coordinates data to the processor 30. The processor 30 determines, based on the coordinates data, which key or icon is touched by the user.

Specifically, an electrostatic capacitance detected at each position of the touch panel 16 is input to the touch panel control circuit 46 as a sensor signal. The touch panel control circuit 46 calculates a detection value corresponding to a changing amount of the electrostatic capacitance at each position based on the input signal, and performs comparison processing the detection value with a detection threshold value being set at the position (area). Then, in a case that the detection value exceeds the detection threshold value, a position corresponding to the detection value is detected as a touch position and coordinates data at the position is output to the processor 30. In addition, a threshold value determination of the detection value may be performed by the processor 30.

In addition, a touch operation is not limited to an operation by a finger, may be performed by a touch pen that an electric conductor is attached at a tip end thereof or the like. Furthermore, for a detection system of the touch panel 16, a surface-type electrostatic capacitance system may be adopted, or a resistance film system, an ultrasonic system, an infrared ray system, an electromagnetic induction system or the like may be adopted. Furthermore, it is possible to use an on-cell touch panel that touch sensors are formed on a surface of a display panel.

The camera module 48 includes a camera control circuit 52 connected to the processor 30, and in the camera control circuit 52, a motor which adjusts a position of an image sensor 54 and/or a focus lens 56 (focus) in response to instructions from the processor 30 is included. The camera control circuit 52 converts an optical image taken-in from the image sensor 54 into image or video data so as to input to the processor 30. That is, the camera module 48 is utilized for imaging a still image or a moving image by the mobile terminal 10.

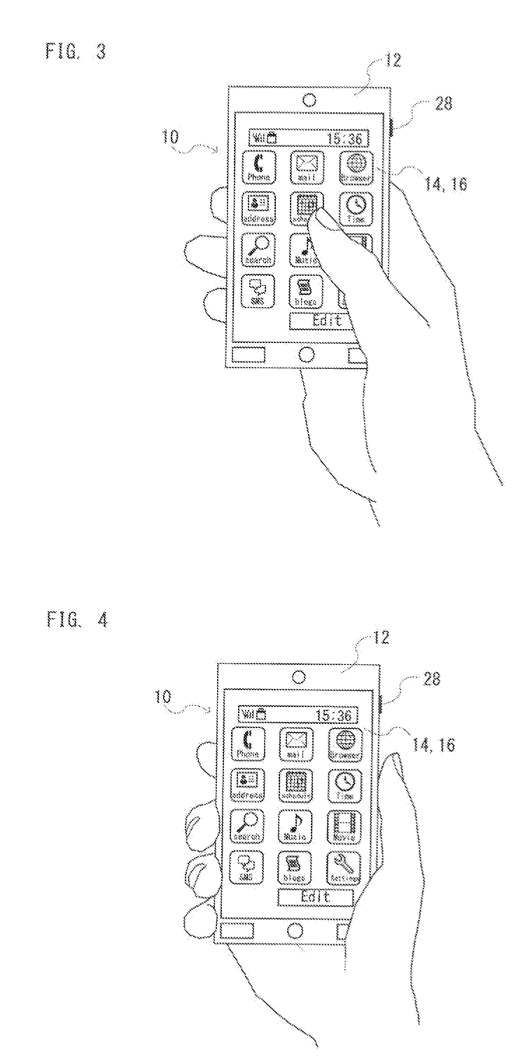

Next, an outline of the operation of this embodiment shown will be described. For example, an input operation is to be performed with using the touch panel 16, the user holds the mobile terminal 10 by one hand as shown in FIG. 3, and in such a state, moves a thumb as a fulcrum at a root of the thumb of the hand so as to perform a touch operation. However, at a timing of such an input operation, a portion of the root of the thumb unintentionally comes in contact with the touch panel, and therefore, there is an occasion that malfunction that an operating key or icon that the user does not intend to operate reacts, a displayed image is unintentionally scrolled, or the like occurs. Furthermore, for example, if the user wishes to see an image being displayed on the display 14, the user grasps side surfaces of the housing 12, while not touching the touch panel 16, as shown in FIG. 4. However, when the hand is moved in a state that the mobile terminal 10 is grasped by the hand, for example, if the user wishes to show another person an image being displayed on the display 14, the user may face the display 14 to the person or the user may hand the mobile terminal 10 itself to the person, and there is an occasion that a fingertip of the user or the like is unintentionally brought into contact with the touch panel 16. In such a case, malfunction that an unintentional operating key and/or icon reacts and thus an image being displayed is displaced or scrolled may occur.

Therefore, in this embodiment, it becomes possible to set a low sensitivity region 60 where the sensitivity of the touch panel 16 is made lower than the sensitivity in the central portion (an area other than an area where the low sensitivity region 60 is set) in a peripheral edge portion of the touch panel 16 in response to an operation of the setting key 28 by the user. This is based on an investigation result that an unintentional contact with the touch panel 16 often occurs in the peripheral edge portion of the touch panel 16.

The setting key 28 is a hard key of a push button type that two (2)-phase of ON/OFF can be switched, for example, and a setting operation of the low sensitivity region 60 by the user can be made in an arbitrary screen or a state. It is preferable for the user that the setting operation for the low sensitivity region 60 may be performed at a time that an initial setting is performed after a mobile terminal 10 newly bought, or a time that a specific application is used.

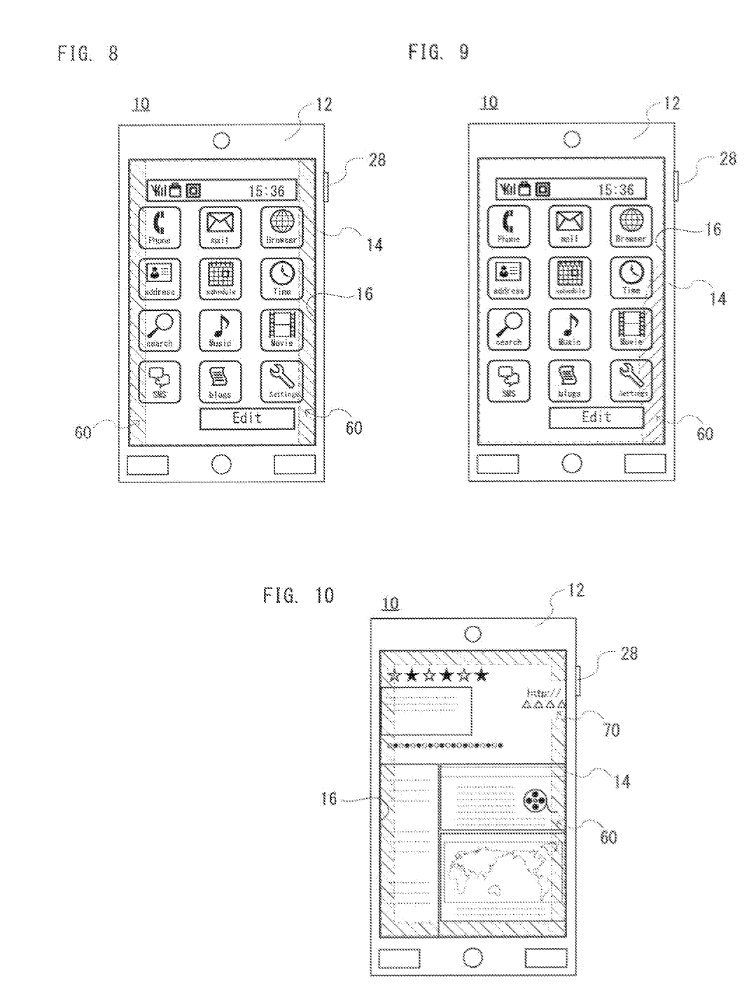

FIG. 5 is an illustrative view for explaining a manner of a low sensitivity region 60 to be set on the touch panel 16. In addition, in FIG. 5, in order to deepen understanding, a low sensitivity region 60 is shown by slant lines, but in fact, the low sensitivity region 60 is not visually displayed, and thus, in use of the mobile terminal 10, the low sensitivity region 60 cannot be recognized by a user (this is true for FIGS. 8-10 described later).

In a menu screen as shown in FIG. 5(A), for example, if the setting key 28 is depressed, as shown in FIG. 5(B), a low sensitivity region 60 is set in a peripheral edge portion of the touch panel 16 (switched to a low sensitivity mode). More specifically, with respect to a predetermined coordinates range (setting range) in the peripheral edge portion of the touch panel 16, processing for lowering the sensitivity of the coordinates range, e.g. processing for increasing a detection threshold value which decides sensitivity is performed. For example, the low sensitivity region 60 is set in a frame-shape surrounding four (4) sides of the touch panel 16 with a width having a predetermined length (5-10 mm, for example) and extending from an outer end edge of the touch panel 16 toward an inside thereof.

In a state that the low sensitivity region 60 is thus set, even if a user unintentionally comes into contact with the low sensitivity region 60, an operating key, icon or the like existing within the low sensitivity region 60 is hard to react, and therefore, occurrence of malfunction is prevented. Furthermore, in a central portion of the touch panel 16 that a low sensitivity region 60 is not set, sensitivity is set at normal sensitivity, and therefore, no interference occurs in operability of the touch panel 16. In addition, the low sensitivity region 60 lowers sensitivity only, even for an operating key, icon or the like existing in the low sensitivity region 60, an operation itself of the operating key, icon or the like is possible.

On the other hand, in a state that a low sensitivity region 60 is set as shown in FIG. 5(B), if the setting key 28 is depressed, the low sensitivity region 60 is cancelled so as to be switched to a normal sensitivity mode. That is, processing for returning the sensitivity of the low sensitivity region 60 is performed, and an entire input-effective area of the touch panel 16 is set with the same sensitivity.

In addition, not only the two-phase switching that the low sensitivity region 60 is set/not set within a predetermined range of the peripheral edge portion of the touch panel 16 but also three (3) or more-phase switching of the sensitivity in the low sensitivity region 60 as first sensitivity, second sensitivity, - - - at every timing of depression of the setting key 28 can be performed. Alternatively, a setting range of the low sensitivity region 60 may be switched in a plural phases such as a first setting range, a second setting range - - - at every timing of depression of the setting key 28. Furthermore, both the setting range and the sensitivity of the low sensitivity region 60 may be changed by the setting key 28 such that the sensitivity of the low sensitivity region 60 is switched by a normal key operation and the setting range of the low sensitivity region 60 is switched by a key operation after long-depression of the setting key 28. Furthermore, the switching of the setting range and the sensitivity of the low sensitivity region 60 by the setting key 28 may be performed with a continuous change but not a stepwise change. By making a user arbitrarily change or switch the setting range and/or the sensitivity of the low sensitivity region 60, a setting of the low sensitivity region 60 suitable for each user can be performed, whereby the occurrence of malfunction due to an unintentional contact with the touch panel 16 can be effectively reduced, and the operability of the touch panel 16 can be increased.

Although not shown, a kind of the hard key which is used as a setting key 28 may be suitably changed, and as a setting key 28, for example, a dial-style hard key may be used, or a push-button hard key including UP key and DOWN key may be used.

Furthermore, when the low sensitivity region 60 is to be set, the low sensitivity region 60 may be expressly and visually displayed so that the user can visually recognize a setting range in which the low sensitivity region 60 is set. For example, slant lines may be applied to the low sensitivity region 60 while an image can be seen through the slant lines or a color having a transparency may be applied to the low sensitivity region 60 such that an image can be seen through the color. In addition, the visual displaying of the low sensitivity region 60 may be performed during a few seconds at a time of setting operation or after setting of the low sensitivity region, or may be always performed during a period that the low sensitivity region 60 is being set. Thus, the user can clearly recognize the setting range of the low sensitivity region 60.

Furthermore, at a time of a state that a low sensitivity region 60 is set, an icon 62 indicating that the low sensitivity region 60 is being set may be displayed in an upper portion of the screen. For example, as shown in FIG. 5(B), such an icon 62 may be displayed in parallel with picto icons indicative of a reception status, a residual battery capacity, etc. Thus, it is possible for the user to recognize that the low sensitivity region 60 is being set.

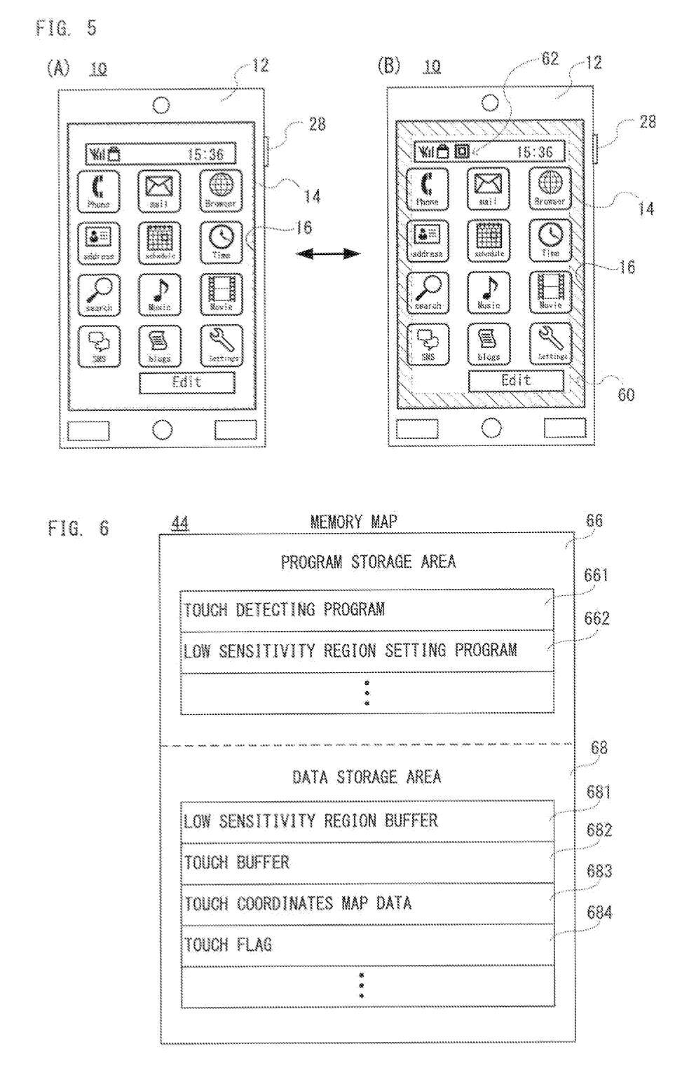

FIG. 6 is a view showing one example of a memory map of the RAM 44 shown in FIG. 2. As shown in FIG. 6, the RAM 44 is formed with a program storage area 66 and a data storage area 68. The program storage area 66 is an area for storing (developing) a part or all of the program data set in advance in the flash memory 42 (FIG. 2) by reading the same from the flash memory 42, as aforementioned.

The program storage area 66 includes a touch detecting program 661, a low sensitivity region setting program 662, etc. which are executed by the processor 30, the touch panel control circuit 46, etc. The touch detecting program 661 is a program for detecting a touch operation to the touch panel 16. The low sensitivity region setting program 662 is a program for setting a low sensitivity region 60 in the peripheral edge portion of the touch panel 16 in accordance with an operation of the setting key 28 or the like (setting inputting portion) by the user, as described in FIG. 5. That is, a program for designating a setting range of the low sensitivity region 60 and/or a detection threshold value for deciding the sensitivity in the low sensitivity region 60 in accordance with an operation of the setting key 28 or the like by the user.

The data storage area 68 includes a low sensitivity region buffer 681, a touch buffer 682, a touch coordinates map data 683, a touch flag 684, etc.

The low sensitivity region buffer 681 is stored with data of a coordinates range of the set low sensitivity region 60 and data of the detection threshold value which decides the sensitivity in the low sensitivity region 60. Furthermore, in the touch buffer 682, data of touch coordinates obtained by the touch operation such as a touch point, a release point, a current touch position and so on is temporarily stored. The coordinates map data 683 is data for converting the touch coordinates stored in the touch buffer 682 into displaying coordinates on the display 14.

The touch flag 684 is a flag for determining whether or not the touch operation is detected. For example, the touch flag 684 is formed by one(1)-bit register. If the touch flag 684 is turned-on (truth), a data value “1” is set in the register. If the touch flag 684 is turned-off (failure), a data value “0” is set in the register. The turn-on/-off of the touch flag 684 is switched on the basis of a threshold value determination with respect to the change of the electrostatic capacitance of the touch panel 16.

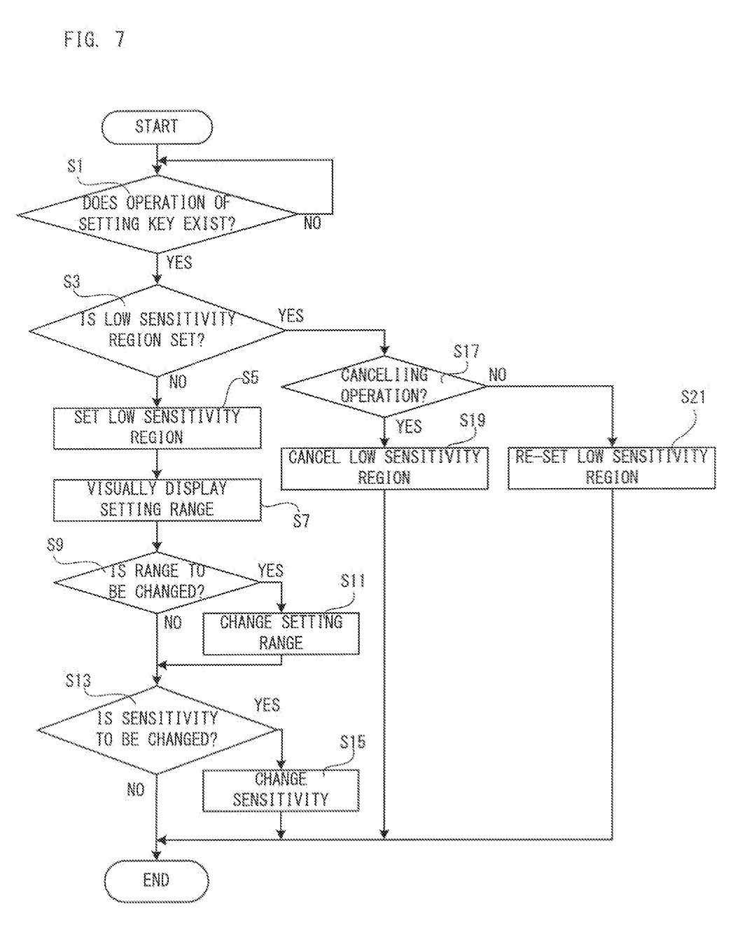

Subsequently, one example of an operation of this embodiment will be described with using a flowchart. A low sensitivity region setting process shown in FIG. 7 is executed mainly by the processor 30 based on a setting operation by the user.

In a step S1, it is determined whether or not an operation of the setting key 28 exists, that is, whether or not there is an input signal from the setting key 28. In a case that “NO” is determined in the step S1, that is, in a case that the setting key 28 is not operated, the processing is repeated again. On the other hand, in a case that “YES” is determined in the step S1, that is, in a case that the setting key 28 is operated, the process proceeds to a step S3.

In the step S3, it is determined whether or not a low sensitivity region 60 is set. That is, a current state is determined on whether data indicating a setting range of the low sensitivity region 60 and a detection threshold value are stored in the low sensitivity region buffer 681. In a case that “NO” is determined in the step S3, that is, in a case that a low sensitivity region 60 is not set, the process proceeds to a step S5.

In the step S5, a low sensitivity region 60 is set in a peripheral edge portion of the touch panel 16. That is, data designating a setting range of the low sensitivity region 60 and a detection threshold value are output to be stored in the low sensitivity region buffer 681. The data stored in the low sensitivity region buffer 681 is utilized for a threshold value determination of a detection value by the touch panel control circuit 46 or the processor 30 in detecting a touch operation to the touch panel 16.

In a next step S7, a setting range of the low sensitivity region 60 is visually displayed. That is, instructions are sent to the display driver 40 to control the displaying of the display 14 such that a color is applied to the setting range of the low sensitivity region 60, for example.

In a next step S9, it is determined whether or not the setting range of the low sensitivity region 60 is to be changed. That is, it is determined whether or not an operation of the setting key 28 changing the setting range of the low sensitivity region 60 is performed. In a case that “YES” is determined in the step S9, that is, in a case that the setting range of the low sensitivity region 60 is to be changed, in a next step S11, the setting range of the low sensitivity region 60 stored in the low sensitivity region buffer 681 is re-written and the process proceeds to a step S13. On the other hand, in a case that “NO” is determined in the step S11, that is, in a case that the setting range of the low sensitivity region 60 is not to be changed, the process proceeds to a step S13 with no action.

In the step S13, it is determined whether or not sensitivity of the low sensitivity region 60 is to be changed. That is, it is determined whether or not an operation of the setting key 28 changing the sensitivity of the low sensitivity region 60 is performed. In a case that “YES” is determined in the step S13, that is, in a case that the sensitivity of the low sensitivity region 60 is to be changed, in a step S15, a detection threshold value stored in the low sensitivity region buffer 681 and for deciding the sensitivity of the low sensitivity region 60 is re-written. On the other hand, in a case that “NO” is determined in the step S13, that is, if the sensitivity of the low sensitivity region 60 is not to be changed, the low sensitivity region setting process is terminated.

In addition, in a case that “YES” is determined in the step S3, that is, if the low sensitivity region has been set, in a step S17, it is determined whether or not a canceling operation occurs. That is, in the step S17, it is determined either whether or not an operation of the setting key 28 canceling the setting of the low sensitivity region 60 is performed or whether or not an operation of the setting key 28 changing the setting range or the sensitivity of the low sensitivity region 60 is performed.

In a case that “YES” is determined in the step S17, that is, if a canceling operation of the low sensitivity region 60 is performed, in a next step S19, the setting of the low sensitivity region 60 is canceled. That is, an entire input-effective area of the touch panel 16 is returned to the same sensitivity. On the other hand, in a case that “NO” is determined in the step S17, that is, if the setting changing operation of the low sensitivity region 60 is performed, in a next step S21, the low sensitivity region 60 is re-set. That is, the setting range of the low sensitivity region 60 and the detection threshold value which decides the sensitivity of the low sensitivity region 60 both being stored in the low sensitivity region buffer 681 are re-written. In addition, in a case that the setting key 28 is only for two-phase switching that the low sensitivity region 60 is set/not set on the touch panel 16, the processing of the steps S9-S15 and the processing of the steps S17 and S21 are omitted.

According to this embodiment, since the low sensitivity region 60 can be set with respect to the peripheral edge portion of the touch panel 16, that is, a portion that the user often unintentionally touches thereto, occurrence of malfunction due to the unintentional touch to the touch panel 16 can be reduced, and the operability of the touch panel 16 can be increased. The advantages of the embodiment are larger in a mobile terminal 10 such as a smartphone or the like that a display is made a big screen and thus a frame width is made small while an input-effective area of the touch panel 16 is formed in an approximately entire range of the displaying area of the display 14.

In addition, in FIGS. 3 and 4, a manner that the mobile terminal 10 is operated or held by a right hand, but in a case that the mobile terminal 10 is operated and held by a left hand or a case that a mobile terminal 10 is held by one hand and operated by the other hand (that is, a case that the mobile terminal 10 is operated by both hands), malfunction due to the unintentional touch to the touch panel 16 similarly occurs, and therefore, it is also effective that the low sensitivity region 60 is set in the peripheral edge portion of the touch panel 16.

Furthermore, in the above-described embodiment, the setting key 28 is provided as a dedicated hard key for setting operation of the low sensitivity region 60, but not limited, and it is possible to use another hard key such as a sound volume key provided on the mobile terminal 10 as the setting key 28. For example, in a case that the sound volume key is used as the setting key 28 that is operated for setting the low sensitivity region 60, an arrangement may be employed such that with a normal operation a sound volume is changed, and with an operation after long-depression, the low sensitivity region 60 is set or changed. Furthermore, an arrangement for automatically switching functions depending on the use of the mobile terminal 10 may be employed such that, for example, when a telephone conversation function or a television function is enabled, the key functions as the sound volume key, and when a Web function or a character inputting function is enabled, the key functions as the setting key 28 for setting the low sensitivity region 60.

Furthermore, it is possible to employ an arrangement that the low sensitivity region 60 may be set by using a soft key by the touch panel 16. That is, it is possible to utilize a soft key by the touch panel 16 as a setting inputting portion that accepts an input operation by the user. For example, by respectively operating soft keys which are displayed in a setting screen appearing in response to an operation of the menu key 26, ON/OFF of the low sensitivity region 60, the setting range (coordinates range), sensitivity (detection threshold value) and so on may be set. By this, it becomes possible to set a range and sensitivity of the low sensitivity region 60 more finely. It becomes unnecessary to provide a hard key, mechanical structure of the mobile terminal 10 can be simplified.

Of course, it is possible to employ an arrangement that the setting operation by the hard key and the setting operation by the soft key both are executable. For example, the switching such as ON/OFF of the setting of the low sensitivity region 60 is made by an operation of the hard key, and fine setting or change such as the setting range and the sensitivity may be made by an operation of the soft key.

Furthermore, in the above-described embodiment, the low sensitivity region 60 is set in a frame shape extending over four (4) sides of the peripheral edge portion of the touch panel 16, but an arbitrary manner can be adopted in the setting range of the low sensitivity region 60 (position, shape and size). For example, as shown in FIG. 8, the low sensitivity region 60 may be set at both two (2) sides only of the peripheral edge portion of the touch panel 16, and further, not shown, the low sensitivity region 60 may be set on arbitrary one (1)-three (3) sides of the peripheral edge portion of the touch panel 16 such as only one (1) right side or left side, or only two (2) right and bottom sides. Furthermore, for example, as shown in FIG. 9, as a low sensitivity region 60 of an indeterminate shape is set in the lower right of the peripheral edge portion of the touch panel 16, the low sensitivity region 60 may be set while a portion that the user often unintentionally touches thereto is selected.

Furthermore, a link region detecting portion which detects a link region 70 linked at a time of Web reading may be provided, and a coordinates region that the link region 70 is detected is excluded from the low sensitivity region 60. That is, as shown in FIG. 10, even in a state that the low sensitivity region 60 is set, when a Web reading screen is displayed and the link region 70 overlaps the low sensitivity region 60, the setting of the low sensitivity region 60 as to the link region 70 may be automatically canceled. Thus, the link region 70 that is more likely to be touch-operated by the user may be configured not to be the low sensitivity region 60 to maintain the operability of the touch panel 16. In addition, for a detection of the link region 70 in Web reading, a marketed software program may be utilized, and therefore, the processor 30 executing this program functions as a link region detecting portion.

Furthermore, in a calibration mode, for example, the setting range and the sensitivity of the low sensitivity region 60 may be made settable for each user on the basis of a state that the user normally holds the mobile terminal 10 by a hand(s). In such a case, prior to the setting of the low sensitivity region 60, for example, by making the user perform a practical operation of the touch panel 16 such as sentence input and data related to the touch operation accumulated at a time of the practical operation may be utilized. For example, at a time of such a practical operation, if a touch operation that a changing amount of the electrostatic capacitance is small in comparison with a normal touch operation is more likely to be detected in a right side of the peripheral edge portion of the touch panel 16, a low sensitivity region 60 that is set with sensitivity that at least such a touch operation that a changing amount of the electrostatic capacitance is small is not detected may be set in a right side of the peripheral edge portion of the touch panel 16. By making it possible to set the setting range and the sensitivity of the low sensitivity region 60 for each user, the occurrence of the malfunction due to the unintentional contact with the touch panel 16 can be more efficiently reduced, and the operability of the touch panel 16 is more increased.

Furthermore, in the above-described embodiment, the sensitivity within the low sensitivity region 60 is set constant entirely, but not limited. For example, it is possible to set such that the sensitivity is gradually increased as going from an outer edge portion of the low sensitivity region 60 to the inner portion thereof.

Furthermore, in the above-described embodiment, the user can select whether the low sensitivity region 60 is to be set or not, but the low sensitivity region 60 may be always set irrespective of selection by the user. Furthermore, only at a time that the user uses a specific application with which the malfunction due to an unintentional contact is easy to occur, for example, only at a time that a character input screen or a screen for seeing a camera image is selected, the low sensitivity region 60 may be automatically set in response to such a selection.

Furthermore, there is a trend that an unintentional contact to the touch panel 16 by the user occurs at a right side of the peripheral edge portion of the touch panel 16 in conjunction with a user operating the mobile terminal 10 by a right hand (right-handed user), and occurs at a left side of the peripheral edge portion of the touch panel 16 in conjunction with a user operating the mobile terminal 10 by a left hand (left-handed user). Therefore, by detecting whether the user is a right-handed person or a left-handed person, and according to a user's dominant hand, the setting range of the low sensitivity region 60 may be automatically changed, whereby the occurrence of the malfunction due to the unintentional contact with the touch panel 16 can be more efficiently reduced, and the operability of the touch panel 16 is more increased. For example, by accumulating the detection data of the touch operation for each coordinate area of the touch panel 16, a user that a touch operation to a right side of the peripheral edge portion is more likely to be detected in comparison with a touch operation to a left side of the peripheral edge portion is determined as a right-handed person. Then, after it is determined that the user is a right-handed person, the low sensitivity region 60 may be set only in a right side of the peripheral edge portion of the touch panel 16, for example.

A plurality of programs utilized in the above-described embodiments may be stored in a HDD of the server for data distribution, and distributed to the mobile terminal 10 via the network. The plurality of programs may be stored in a storage medium such as an optical disk of CD, DVD, BD (Blu-ray Disc) or the like, a USB memory, a memory card, etc. and then, such the storage medium may be sold or distributed. In a case that the plurality of programs downloaded via the above-described server or storage medium are installed to a mobile phone having the structure equal to the structure of the embodiment, it is possible to obtain advantages equal to advantages according to the embodiment.

The specific numerical values mentioned in this specification are only examples, and changeable properly in accordance with the change of product specifications.

An embodiment is a mobile terminal provided with a touch panel, comprising: a setting inputting portion; and a setting portion which sets, based on an operation by a user to the setting inputting portion, a low sensitivity region that is lowered sensitivity than a central portion of the touch panel in a peripheral edge portion of the touch panel.

In this embodiment, a mobile terminal (10: a reference numeral exemplifying a corresponding portion in the embodiment, and so forth) is a smartphone as an example, and comprises a touch panel (16) provided on a display (14). A setting inputting portion (16, 28) accepts an input operation by a user. A setting portion (30, 662, S5) is a processor (30) executing a low sensitivity region setting program (662), etc., for example, and sets, in a peripheral edge portion of the touch panel, a low sensitivity region (60) that is lowered sensitivity than a central portion of the touch panel. A change of the sensitivity of the touch panel (lowering the sensitivity of the low sensitivity region) is performed by changing a detection threshold value for deciding the sensitivity, or the like.

According to the embodiment, since a low sensitivity region can be set in a peripheral edge portion of the touch panel that the user is more likely to unintentionally contact therewith, it is possible to reduce occurrence of malfunction due to an unintentional contact with the touch panel and to increase operability of the touch panel.

Another embodiment is a mobile terminal, wherein the setting inputting portion includes a sensitivity inputting portion which changes the sensitivity of the low sensitivity region, and the setting portion sets the sensitivity of the low sensitivity region at sensitivity according to an operation of the sensitivity inputting portion.

In this embodiment, the mobile terminal (10) comprises a sensitivity inputting portion (16, 28) which accepts an input operation by the user for changing the sensitivity of the low sensitivity region (60). The setting portion (30, 662) sets the sensitivity of the low sensitivity region at sensitivity according to an operation of the sensitivity inputting portion.

According to the embodiment, since it becomes possible to set sensitivity of the low sensitivity region suitable for each user, and thus to more reduce the occurrence of the malfunction and to more increase the operability of the touch panel.

A further embodiment is a mobile terminal, wherein the setting inputting portion includes a range inputting portion which changes a setting range of the low sensitivity region, and the setting portion sets the setting range of the low sensitivity region according to a range according to an operation of the range inputting portion.

In the further embodiment, the mobile terminal (10) comprises a range setting portion (16, 28) which accepts an input operation by the user for changing a setting range of the low sensitivity region (60). The setting portion (30, 662) sets the range (position, shape, size, etc.) of the low sensitivity region to a range according to an operation of the range inputting portion (S11, S21).

According to the further embodiment, since it becomes possible to set the range of the low sensitivity region suitable for each user, and thus to more reduce the occurrence of the malfunction and to more increase the operability of the touch panel.

A still further embodiment is a mobile terminal wherein the setting inputting portion includes a hard key provided outside the touch panel.

In the still further embodiment, the setting inputting portion (16, 28) includes a hard key (28) provided separately from the touch panel (16). As the setting inputting portion, a push button type hard key capable of switching ON/OFF by depressing, for example.

According to the still further embodiment, it becomes possible to easily set the low sensitivity region by utilizing the hard key by the user,

Another embodiment is a mobile terminal wherein the setting inputting portion includes a soft key by the touch panel.

In this embodiment, the soft key by the touch panel (16) is utilized as a setting inputting portion (16, 28) accepting an input operation by the user

According to the embodiment, it becomes possible to set the setting range, the sensitivity or the like of the low sensitivity region finely. Furthermore, because there is no need to provide a hard key, mechanical structure of the mobile terminal can be simplified.

A still another embodiment is a mobile terminal, further comprising a region displaying portion which visually displays the low sensitivity region.

In this embodiment, the low sensitivity region is visually displayed on the display (14) in a manner that a color is applied to the setting range of the low sensitivity region, for example.

According to the embodiment, it becomes possible for the user to clearly recognize the setting range of the low sensitivity region.

A further another embodiment is a mobile terminal, further comprising a link region detecting portion which detects a link region being linked in reading Web thereto, wherein the setting portion excludes the link region detected by the link region detecting portion from the low sensitivity region.

In this embodiment, the link region detecting portion (30) detects a link region (70) to which Web is linked in reading the Web. The setting portion (30, 662) cancels, when the link region overlaps the low sensitivity region (60), the setting the link region as the low sensitivity region.

According to the embodiment, the operability of the touch panel is increased because a link region that is more likely to be touched by the user is not formed as the low sensitivity region.

Another embodiment is a mobile terminal provided with a touch panel, comprising: a setting portion which sets a low sensitivity region that is lowered sensitivity than a central portion of the touch panel in a peripheral edge portion of the touch panel.

In this embodiment, a mobile terminal (10) is a smartphone as an example and comprises a touch panel (16) provided on a display (14). A setting portion (30, 662, S5) is a processor (30) executing a low sensitivity region setting program (662), etc., and sets, in a peripheral edge portion of the touch panel, a low sensitivity region (60) that is lowered sensitivity than a central portion of the touch panel. A change of the sensitivity of the touch panel is performed by changing a detection threshold value for deciding the sensitivity, or the like.

According to the embodiment, since a low sensitivity region can be set in a peripheral edge portion of the touch panel that is a portion that the user is more likely to unintentionally contact therewith, it is possible to reduce occurrence of malfunction due to an unintentional contact with the touch panel and to increase operability of the touch panel.

The other embodiment is a controlling method of a mobile terminal which includes a setting inputting portion and a touch panel provided on a display, comprising a step of setting a low sensitivity region that is lowered sensitivity than a central portion of the touch panel in a peripheral edge portion of the touch panel.

According to the other embodiment, since a low sensitivity region can be set in a peripheral edge portion of the touch panel that is a portion that the user is more likely to unintentionally contact therewith, it is possible to reduce occurrence of the malfunction due to an unintentional contact with the touch panel and to increase operability of the touch panel.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A mobile terminal provided with a touch panel, comprising:
a setting inputting portion; and
a setting portion which sets, based on an operation by a user to the setting inputting portion, a low sensitivity region that is lowered sensitivity than a central portion of the touch panel in a peripheral edge portion of the touch panel.

2. A mobile terminal according to claim 1, wherein the setting inputting portion includes a sensitivity inputting portion which changes the sensitivity of the low sensitivity region, and the setting portion sets the sensitivity of the low sensitivity region at sensitivity according to an operation of the sensitivity inputting portion.

3. A mobile terminal according to claim 1, wherein the setting inputting portion includes a range inputting portion which changes a setting range of the low sensitivity region, and the setting portion sets the setting range of the low sensitivity region according to a range according to an operation of the range inputting portion.

4. A mobile terminal according to claim 1, wherein the setting inputting portion includes a hard key provided outside the touch panel.

5. A mobile terminal according to claim 1, wherein the setting inputting portion includes a soft key by the touch panel.

6. A mobile terminal according to claim 1, further comprising a region displaying portion which visually displays the low sensitivity region.

7. A mobile terminal according to claim 1, further comprising a link region detecting portion which detects a link region being linked in reading Web thereto, wherein the setting portion excludes the link region detected by the link region detecting portion from the low sensitivity region.

8. A mobile terminal provided with a touch panel, comprising:
a setting portion which sets a low sensitivity region that is lowered sensitivity than a central portion of the touch panel in a peripheral edge portion of the touch panel.

9. A controlling method of a mobile terminal including a setting inputting portion and a touch panel provided on a display, comprising a step of setting a low sensitivity region that is lowered sensitivity than a central portion of the touch panel in a peripheral edge portion of the touch panel.
